(19) United States
(12) Patent Application Publication
(10) Pub. No.: US 2015/0249693 A1
(43) Pub. Date: Sep. 3, 2015

(54) Method and system for enabling communication between at least two communication devices using an animated character in real-time.

(71) Applicant: Ankush GUPTA, (US)

(72) Inventor: Ankush Gupta, Bangalore (IN)

(21) Appl. No.: 14/433,050

(22) PCT Filed: Oct. 14, 2013
(86) PCT No.: PCT/IN2013/000618

§ 371 Date: Apr. 2, 2015

(30) Foreign Application Priority Data
Oct. 12, 2012 (IN) 4283/CHE/2012

(51) Int. Cl. H04L 29/06; G06F 3/0484; G06F 3/0481; G06T 13/40

(52) U.S. Cl. CPC H04L 65/403; G06T 13/40; G06F 3/04842; G06F 3/0481

(57) ABSTRACT

The various embodiments herein disclose a method and system for enabling communication between at least two communication devices using an animated character in real-time. The method comprises establishing a communication session between a first communication device and a second communication device, transmitting a voice signal and an event message from the first communication device to the second communication device, analyzing the voice signal and an event message by a data analyzer module, creating an animation sequence corresponding to the animated character by an animation engine, displaying the animated character in the second communication device and enabling the animated character to perform a plurality of pre-defined actions on the second communication device. The plurality of pre-defined actions herein comprises at least one of selecting an emotion or performing an activity by the animated character based on one or more control instructions from the first communication device.

### RELATED APPLICATION

Benefit is claimed to Indian Provisional Application No. 2283/CHE/2012 titled “KIDS TELECOMMUNICATION DEVICE” by GUPTA, Ankush, filed on 12 Oct. 2012, which is herein incorporated in its entirety by reference for all purposes.

### FIELD OF THE INVENTION

The present invention relates to the field of communication and more particularly to a communication method and system for enabling communication using an animated character in real-time.

### BACKGROUND OF THE INVENTION

Generally, computer animation is more compelling when it includes realistic human like interaction among the components in a graphics scene. This is especially true when the animated characters in a graphics scene are supposed to simulate life-like interaction. However, using the conventional methods it is difficult for application programs to synchronize the actions of characters so that they appear more life-like.

Most current applications use a time-based scripting system, in which the precise times at which individual actions and gestures evolve in lock step with a clock. This method is very flexible and quite powerful. Unfortunately, it requires a great deal of attention to each frame, it is very time-consuming, and the resulting script is hard to read. These limitations affect the use and availability of animation to designers in the mass market. Since it is particularly difficult to express such scripts in string format, they are particularly unsuitable to the World Wide Web (the Web), over which most control information is transmitted as text.

In conventional systems, the communication system the video and voice are transmitted via the network, which consumes large amount of data and high bandwidth. Moreover, the conventional communication sessions such as chat environment and video communication do not provide an option to animate the animation character in real time using traditional landline telephones. Furthermore, most of the communication sessions involving communication protocols require both the ends to take an action using keyboard or touch screen.

### OBJECTIVE OF THE INVENTION

The objective of the invention is to provide a method of controlling an animated character running on communication device remotely.

Another objective of the invention is to provide a mechanism to control various emotions and activities of an animated character remotely through voice.

Yet another objective of invention is to provide a method and system for creating dynamic real-time video of animated characters using corresponding fragments of videos and images.

Yet another objective of invention is to provide a method and system for enabling state transitions of activities of the animated character.

Yet another objective of invention is to provide a method and system for enabling the communication device adapted to manage one or more class rooms provide real time learning experience.

The foregoing has outlined, in general, the various aspects of the invention and is to serve as an aid to better understanding the more complete detailed description which is to follow. In reference to such, there is to be a clear understanding that the present invention is not limited to the method or application of use described and illustrated herein. It is intended that any other advantages and objects of the present invention that become apparent or obvious from the detailed description or illustrations contained herein are within the scope of the present invention.

### SUMMARY OF THE INVENTION

The various embodiments of the present invention provide a method of enabling communication between at least two communication device using an animated character in real-time. In one aspect of present invention, the method comprises establishing a communication session between a first communication device and a second communication device. Further, the first communication device transmits a voice signal and an event message to the second communication device. The transmitted the voice signal and an event message are analyzed by a data analyzer module in the second communication device. The method further comprises creating an animation sequence corresponding to the animated character based on the analysis by an animation engine and displaying the animated character in the second communication device. The method according to present invention enables the animated character to perform a plurality of pre-defined actions on the second communication device, wherein the plurality of pre-defined actions comprises at least one of selecting an emotion or performing an activity by the animated character based on one or more control instructions from the first communication device.

Additionally, the method comprises activating a communication application pre-installed in the first communication device and the second communication and selecting an animated character corresponding to a pre-defined user identity. Furthermore, the method comprising dividing the received voice signal based on a predefined duration at a pre-defined frame rate and computing maximum amplitude of the voice signal for the predefined duration. The method comprising extracting a plurality of header attributes, identifying one or more commands provided in a header of the event message, and mapping at least one of an emotion or activity based on the plurality of header attributes.

The method further comprises selecting one or more image frames based on the computed amplitude of the voice signal, selecting one or more image frames or video frames corresponding to the selected animated character, performing a frame animation on the selected one or more image frames, performing a video animation on the selected one or more image frames or video frames corresponding to the selected animated character based on the one or more commands in the event message and combining the frame animated image frames and the video animated video frames to create the animation sequence. The method further comprising modulating the received voice signal based on the selected animated character.

In another aspect, system for enabling communication between at least two communication devices using an animated character in real-time, the system comprising a first communication device, a server and a second communication device. The second communication device comprising an application module comprising a data analyzer module configured for analyzing the voice signal and an event message and an animation engine configured for creating an animation sequence corresponding to the animated character and enabling the animated character to perform a plurality of pre-defined actions on the second communication device and controlling the animated character based on one or more control instructions from the first communication device. The second communication device further comprising a display module configured for displaying the animated character in the second communication device.

In another aspect, a device for enabling communication using an animated character in real-time, the device comprises a communication module configured for establishing a communication session with another communication device and receiving a voice signal and an event message from another communication device and an application module comprising a data analyzer module and an animation engine. The data analyzer module is configured for analyzing the voice signal and an event message. The animation engine configured for creating an animation sequence corresponding to the animated character based on the analysis by an animation engine and enabling the animated character to perform a plurality of pre-defined actions. Further, the device comprising a user interface module for displaying the animated character.

Additionally, the device comprising a resource repository adapted for storing a plurality of pre-defined animated characters and a plurality of image frames, video frames and audio frames associated with the plurality of animated characters.

Moreover, the data analyzer module of the device according to present invention comprises an attribute extraction module and a voice processing module. The attribute extraction module is configured for extracting a plurality of header attributes identifying one or more commands provided in a header of the event message and mapping at least one of an emotion or activity based on the plurality of header attributes. The voice processing module configured for dividing the received voice signal based on a predefined duration at a pre-defined frame rate and computing maximum amplitude of the voice signal for the predefined duration.

Likewise, the animation engine in the device according to present invention comprises a frame animation module, a video animation module and a frame combining module. The frame animation module is configured for selecting one or more image frames based on the computed amplitude of the voice signal and performing a frame animation on the selected one or more image frames. The video animation module configured for selecting one or more image frames or video frames corresponding to the selected animated character and performing a video animation on the selected one or more image frames or video frames corresponding to the selected animated character based on the one or more commands in the event message. The frame combining module configured for combining the frame animated image frames and the video animated video frames to create the animation sequence.

The device further comprises a voice modulation module configured for modulating the received voice signal based on the selected animated character.

### BRIEF DESCRIPTION OF THE ACCOMPANYING DRAWINGS

FIG. 1 is a block diagram of a communication network for enabling communication using an animated character in real-time, according to an embodiment herein.

FIG. 2 is a process flowchart illustrating an exemplary method of enabling communication between at least two communication devices using an animated character in real-time, according to an embodiment herein.

FIG. 3 is a process flowchart illustrating an exemplary method of analyzing the received voice signal, according to an embodiment herein.

FIG. 4 is a process flowchart illustrating an exemplary method of analyzing the received event message according to an embodiment herein.

FIG. 5 is a process flowchart illustrating an exemplary method of creating the animation sequence according to an embodiment herein.

FIG. 6 is an exemplary illustration of the embodiments disclosed herein.

FIG. 7 is a block diagram illustrating an application module, according to an embodiment herein.

FIG. 8 illustrates an exemplary resource repository, according to an embodiment herein.

FIG. 9 is a flow diagram illustrating signal flow between the first communication device and the second communication device where the inputs from the second communication device are handled locally according to an embodiment herein.

FIG. 10 is a flow diagram illustrating a communication between a first communication device and second communication device wherein the inputs from second communication device are transmitted to first communication device, according to an embodiment herein.

FIG. 11 is a flow diagram illustrating communication between a first communication device and a second communication device wherein the first communication device is a traditional phone, using DTMF digits, according to another embodiment herein.

FIG. 12 is a flow diagram illustrating communication between a first communication device and second communication device, wherein the first communication device is a traditional phone, using voice commands, according to another embodiment herein.

FIG. 13 is a flow diagram illustrating communication between a first communication device and second communication device when the session is established locally on a network without transmitting via a server, according to another embodiment herein.

### DETAILED DESCRIPTION OF THE INVENTION

The present invention provides method, system and device of enabling communication between at least two communication devices using an animated character in real-time. In the following detailed description of the embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limiting sense, and the scope of the present invention is defined only by the appended claims.

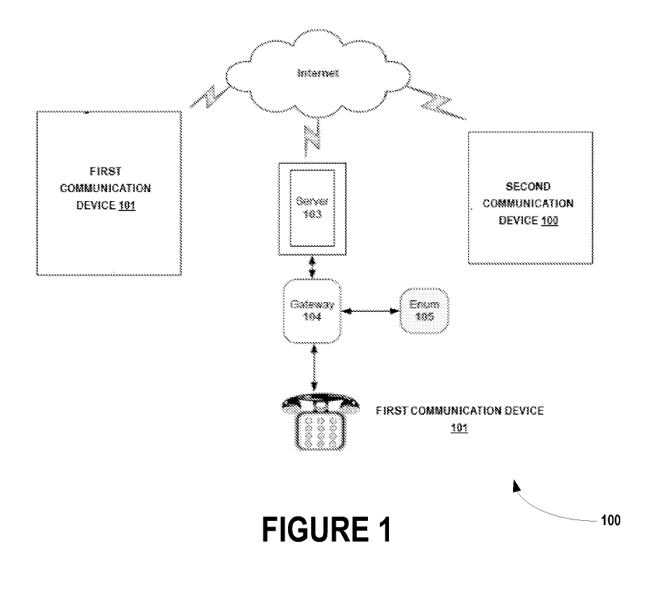

FIG. 1 is a block diagram of a communication network for enabling communication using an animated character in real-time, according to an embodiment herein. The communication network according to present invention includes a first communication device 101, a second communication device 100 and a server 103. The server 103 establishes a communication session between the first communication device 101 and the second communication device 100. In an exemplary embodiment, the first communication device 101 is a caller device and second communication device 100 is a called device and vice versa. The first communication device is a network enabled device such as mobile phone, a laptop, a phablet or any communication devices such as land phone. The second communication device is any communication device which is network enabled and having a display and a camera such as mobile phone, a laptop, a phablet or any such communication devices. The second communication device is capable of receiving voice signal and an event message from the first communication device 101.

According to an embodiment of present invention, the user identity corresponding to the first communication device 101 is registered in the server. A plurality of such user identities is registered in the server. Accordingly, the server authenticate the first communication device 101 to establish a communication session with the second communication device 100, only if the user identity corresponding to the first communication device 101 is registered in the server and vice versa. Once the communication session is established between the first communication device 101 and the second communication device 100, an animated character corresponding to the pre-registered user identity is displayed in the second communication device 100. The animated character displayed in the second communication device 100 is controlled by the first communication device 101. Further, the voice signal corresponding to the user of the first communication device 100 is modulated corresponding to the voice signal of the animation character displayed in the second communication device 100. The server 103 uses the Gateways 104 and ENUM servers 105 or equivalent technology to facilitate the calling of traditional landline phone device 102.

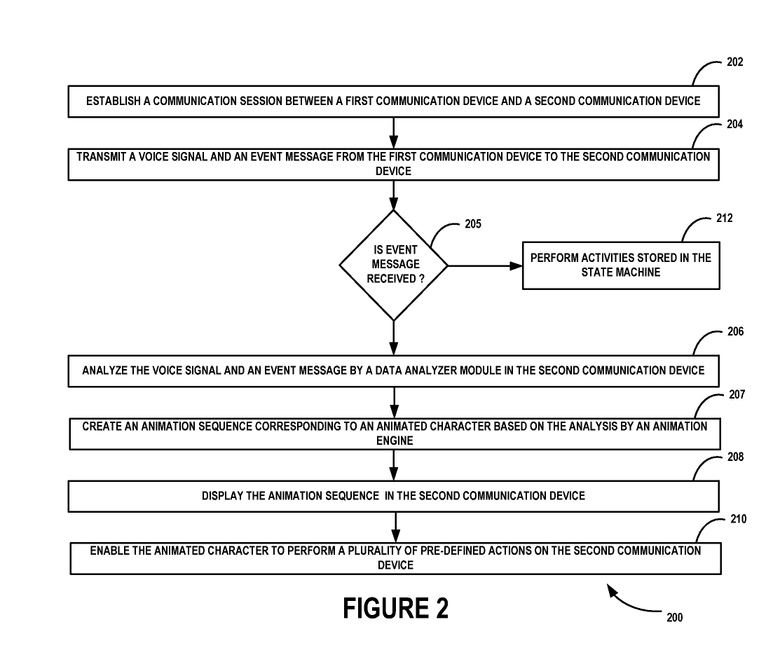

FIG. 2 is a process flowchart illustrating an exemplary method of enabling communication between at least two communication devices using an animated character in real-time, according to an embodiment herein. At step 202, a communication session is established between the first communication device 101 and second communication device 100. At step 204, the voice signal and event message are transmitted to the first communication device 101 from the second communication device 100. The event message transmitted from the first communication device can be any communication interface protocol message. Interface protocol may be an IP Telephony such as VoIP, SIP signaling using Real time transfer protocol (RTP)/RTP control protocol (RTCP) for actual traffic or equivalent protocols. The second communication device 100 is capable of receiving and transmitting SIP messages, and is capable of receiving and transmitting RTP/RTCP data through a network interface.

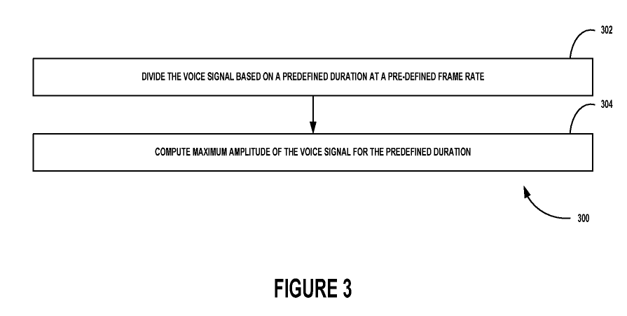

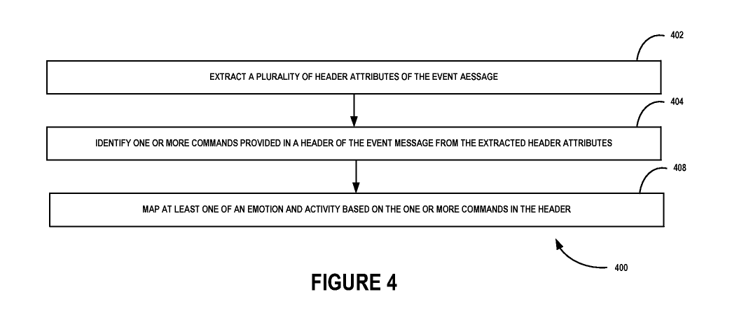

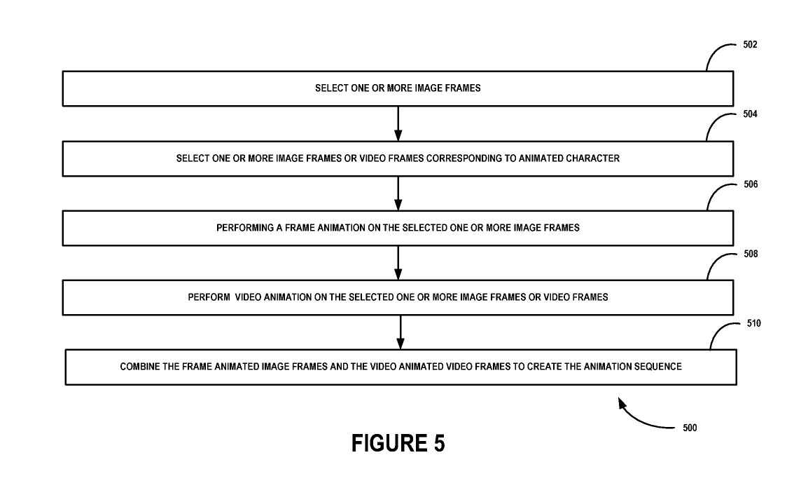

At step 205, the application module 604 of the second communication device 100 determines whether any event message is received from the first communication device. If the second communication device 100 receive any event message, then at step 206, the voice signal and event message are analyzed by a data analyzer module. An exemplary method of analyzing the received voice signal in accordance with the embodiment of present invention is illustrated in FIG. 3. Also, an exemplary method of analyzing the received event message in accordance with the embodiment of present invention is illustrated in FIG. 4. At step 207, an animation sequence corresponding to the animated character is created in the second communication device 100 based on the analyzed voice signal and event message by an animation engine. An exemplary method of creating the animation sequence in accordance with the embodiment of present invention is illustrated in FIG. 5.

According to another embodiment herein, once connection is established to the second communication device 100, the device control gets transferred to the state machine 718 of the application module. The control instructions provided by the state machine 718 enables the animated character to perform at least one of a state comprising an activity state, talking state, a listening state and an idle state.

At step 208, the animated sequence is displayed in the second communication device 100 as per the event message and voice signal received from the first communication device 101. At step 210, the animated character displayed on the second communication device 100 is enabled to perform a plurality of pre-defined actions. The plurality of pre-defined actions comprises selecting an emotion or performing an activity by the animated character based on one or more control instructions send from the first communication device. For example, the control instructions include changing of dress, hair, color or the like in real time. It can further control speaker, microphone volume remotely.

FIG. 3 is a process flowchart illustrating an exemplary method of analyzing the received voice signal, according to an embodiment herein. At step 302, the voice signal is divided based on a predefined duration at a pre-defined frame rate. For example, consider the frame rate is 30 fps, and then time duration for division will be 1/30 of a second. i.e., 0.33 msec. Then at step 304, the maximum amplitude of the voice signal for the predefined duration is calculated.

FIG. 4 is a process flowchart illustrating an exemplary method of analyzing the received event message according to an embodiment herein. The event message comprises a header having header attributes. At step 402, the header attributes are extracted. In an exemplary embodiment, the header attributes comprises emotion and activity. The values for the header attributes are commands. At step 404, one or more commands provided in a header of the event message are identified. At step 406, at least one of an emotion and activity is mapped based on the one or more commands in the header. For example, consider the interface protocol implemented in one embodiment of present invention is SIP. Then the SIP message or equivalent mid-session message is used to convey the desired emotion/activity from the first communication device 101 to the second communication device 100. The SIP message uses a new header and Header: attribute=value format for e.g. emotion=value wherein value includes joy, sad, laugh, wink, surprise etc. The SIP message uses an activity=value parameter wherein value includes dancing, eye-blinking, drink-milk, study, sleep etc. Additionally another parameter “duration=<time in milliseconds>, could be sent to instruct application module in the second communication device 100 to play animation for specified number of milliseconds.

FIG. 5 is a process flowchart illustrating an exemplary method of creating the animation sequence according to an embodiment herein. In an exemplary embodiment, at step 502, one or more image frames are selected based on the computed amplitude of the voice signal (step 304 of FIG. 3) transmitted from the first communication device 101. At step 504, one or more image frames or video frames corresponding to the selected animated character is selected based on the identified commands of the event message. At step 506, a frame animation is performed on the selected one or more image frames corresponding to the voice signal in order to generate lip-sync on the animated character displayed in the second communication device 100 in real time. At step 508, a video animation is performed on the selected one or more image frames or video frames corresponding to the selected animated character based on the one or more commands in the event message. For example, the first communication device 101 transmits the event message comprising commands for dancing and laughing together with a voice signal, then video animation is performed in the video frames corresponding to activity dancing and emotion laughing. At step 510, the frame animated image frames and the video animated video frames are combined to create the animation sequence corresponding to the animated character.

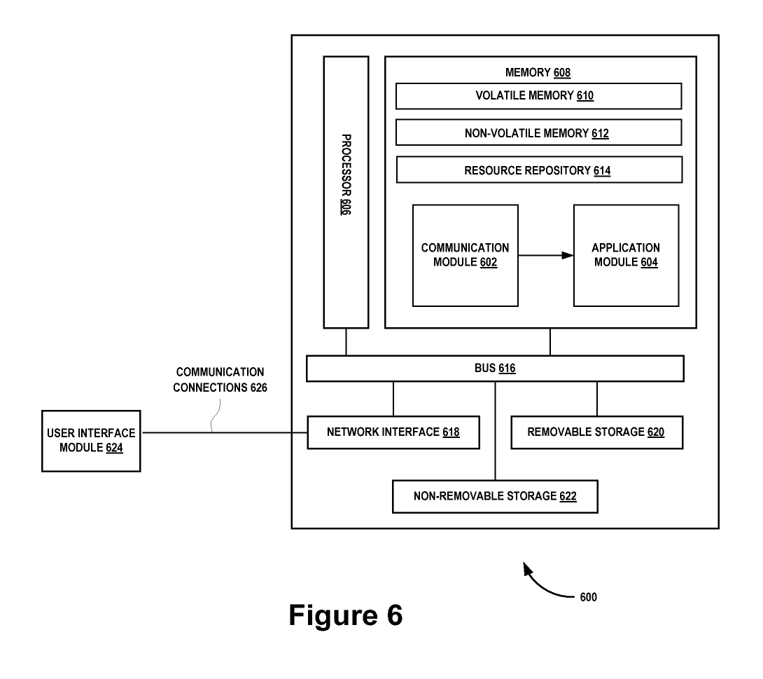

FIG. 6 is an exemplary illustration of the embodiments disclosed herein. FIG. 6 and the following discussion are intended to provide a brief, general description of the handheld device in which certain embodiments of the inventive concepts contained herein may be implemented. The communication device includes a processor 606, a memory 608, a removable storage 620, and a non-removable storage 622. The communication device 600 additionally includes a bus 616 and a network interface 618. The communication device 600 may include or have access to a computing environment that includes one or more user interface modules 624 and one or more communication connections 626 such as a network interface card or a universal serial bus connection. The one or more user interface modules 624 may be a touch screen, microphone, keyboard and a stylus, a speaker or an earphone and the like. The communication connection 626 may include a local area network, a wide area network, and/or other networks.

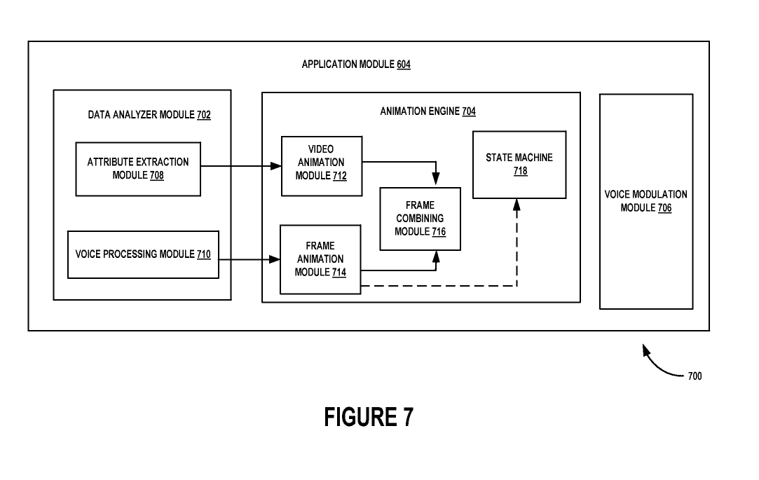

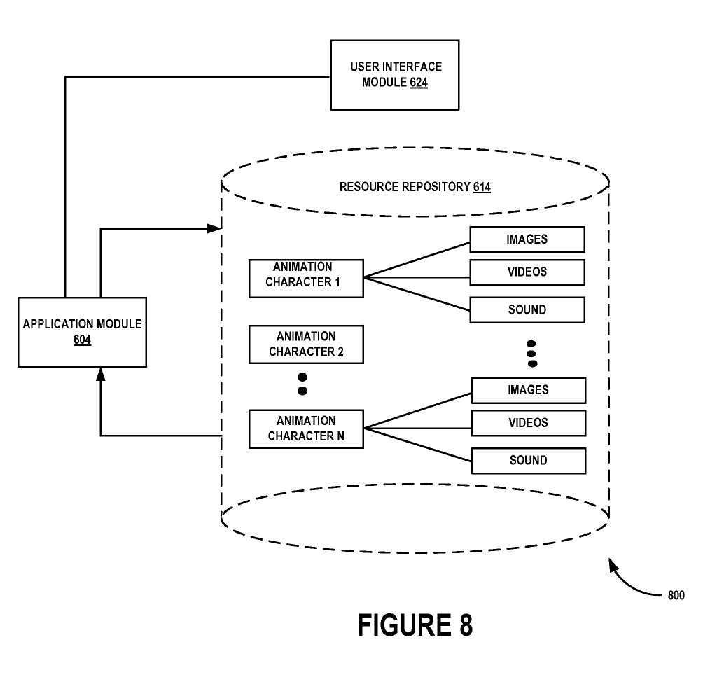

The memory 610 may include a volatile memory 610 and a non-volatile memory 612. The memory 608 includes resource repository 614. A detailed illustration of resource repository according to an exemplary embodiment of present invention is illustrated in FIG. 8. The memory also includes a communication module 602 and an application module 604. The communication module 602 is configured for establishing a communication session with another communication device and receiving a voice signal and an event message from another communication device. The application module according to an exemplary embodiment of present invention is illustrated in detail in FIG. 7.

A variety of computer-readable media may be stored in and accessed from the memory elements of the communication device 600, such as the volatile memory 610 and the non-volatile memory 612, the removable storage 620 and the non-removable storage 622. Memory elements may include any suitable memory device(s) for storing data and machine-readable instructions, such as read only memory, random access memory, erasable programmable read only memory, electrically erasable programmable read only memory, hard drive, removable media drive for handling compact disks, digital video disks, diskettes, magnetic tape cartridges, memory cards, Memory Sticks, and the like.

The processor 606, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a graphics processor, a digital signal processor, or any other type of processing circuit. The processing unit 608 may also include embedded controllers, such as generic or programmable logic devices or arrays, application specific integrated circuits, single-chip computers, smart cards, and the like.

Embodiments of the present subject matter can be implemented in conjunction with program modules, including functions, procedures, data structures, and application programs, for performing tasks, or defining abstract data types or low-level hardware contexts. Machine-readable instructions stored on any of the above-mentioned storage media may be executable by the processing unit 606. The machine-readable instructions may cause the communication device 600 to encode according to the various embodiments of the present subject matter.

FIG. 7 is a block diagram illustrating an application module, according to an embodiment herein. In an exemplary embodiment of present invention, the application module 604 of the communication device comprises a data analyzer module 702, an animation engine 704 and a voice modulation module 706.

The data analyzer module 702 is configured for analyzing the transmitted voice signal and event message. Typically, the data analyzer module 702 comprises an attribute extraction module 708 and a voice processing module 710. The attribute extraction module 708 is configured for extracting a plurality of header attributes and identifying one or more commands provided in a header of the event message and mapping at least one of an emotion and activity based on the plurality of header attributes. The voice processing module 710 is configured for dividing the received voice signal based on a predefined duration at a pre-defined frame rate and computing maximum amplitude of the voice signal for the predefined duration.

The animation engine 704 of the application module 604 comprises a video animation module 712, a frame animation module 714 a frame combining module 716and a state machine 718. The computed amplitude of the voice signal is sent to the frame animation module 714. The frame animation module 714 is configured for selecting one or more image frames based on the computed amplitude of the voice signal and performing the frame animation on the selected one or more image frames. The identified commands of the event message are sent to the video animation module 712. The video animation module 712 configured for selecting one or more image frames or video frames corresponding to the selected animated character and performing the video animation on the selected one or more video frames corresponding to the selected animated character based on the one or more commands in the event message. The outcome of video animation module 712 and frame animation module 714 are sent to the frame combining module 716. The frame combining module716 configured for combining the frame animated image frames and the video animated video frames to create the animation sequence.

The state machine 718 enables the animated character to be in states such as activity, talking, listing and idle. The animation sequence corresponding to the animated character when the second communication device 100 receives voice signal and event messages from the first communication device 101 is created by the state machine 718. According to one embodiment of present invention, the state machine 718 has the states such as activity, talking, listening and idle. Whenever any event message is received state machine 718 moves to activity state till completion of activity or till next event message is received. The animated character is in talking state, whenever the second communication receives voice signals from first device and is not performing any activity. The animated character is in listening state only when it receives voice packets from microphone associated with second communication device, while no voice signals are being received from first device Likewise, the animated character is in idle state, when the first communication device 101 is not transmitting voice signal and event message and no voice signals are received from microphone associated with second communication device.

The voice modulation module 706 determines the bit rate of the voice signal. Subsequently the voice modulation module 706 changes the bit rate of the voice signal according to the animated character displayed on the second communication device 100. A child-like voice effect is created by increasing the bit rate from the voice signal of the user. The modulated voice is played on second communication device 100 through a speaker or an earphone.

FIG. 8 illustrates an exemplary resource repository, according to an embodiment herein. In an exemplary embodiment according to present invention, the animation character corresponding to one or more user identities are stored in the resource repository 614. The resource repository 614 also comprises the video frames for activities corresponding to the animated character according to the user preferences, images and sounds. The application module 604 is fetches the corresponding video and images from the resource repository and displays through the user interface 624.

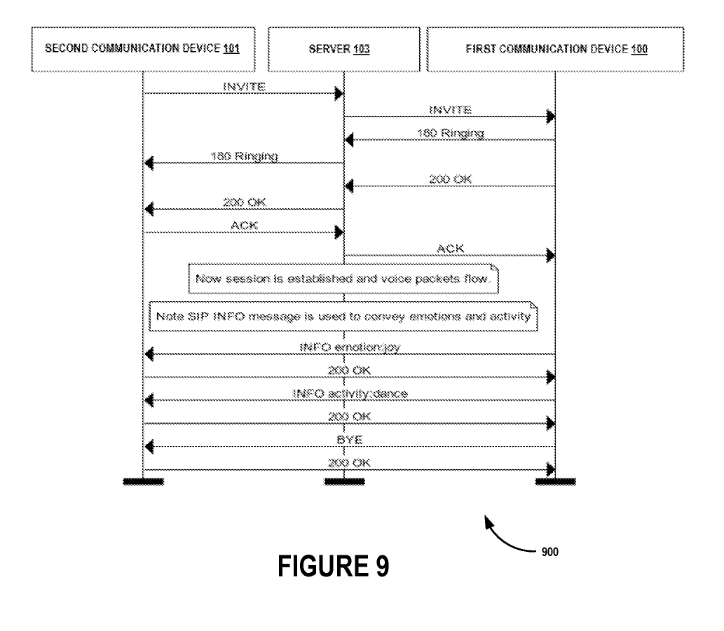

FIG. 9 is a flow diagram illustrating communication between a first communication device and second communication device wherein the inputs from the keyboard or touch screen on device 100 is handled locally without transmitting via the network interface according to an embodiment herein. In an exemplary embodiment, inputs from keyboard or touch screen could be handled locally without transmitting via the network. For e.g. if the user touches the animated character displayed in the screen via the touch screen or mouse, the animated character may move or may perform some funny actions which are not controlled by the user of first device rather it is handled locally in the second communication device 100. This facilitates ease for first communication device as it does not need to respond to all inputs and can just have to perform voice conversation, and control speech, emotions and activities of animated character and does not need to respond to keyboard, mouse, touch-screen input from the animated character. After the SIP call is established, INFO message is used for conveying emotion and activities as explained above.

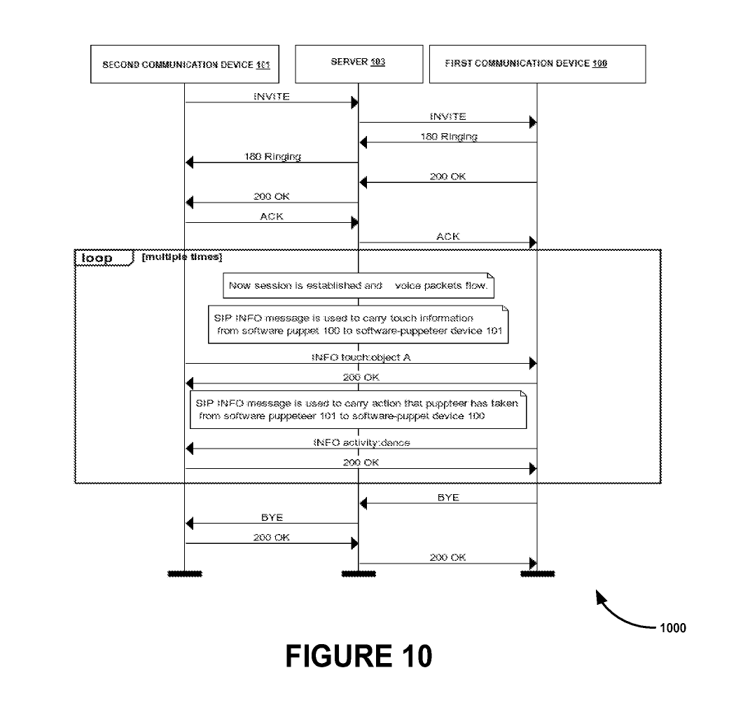

FIG. 10 is a flow diagram illustrating a communication between a first communication device and second communication device wherein the communication session is established via a network interface, according to an embodiment herein. After the SIP call is established the SIP message is used for conveying the touch information from the second communication device 100 to the first communication device 101 as a parameter in SIP message which contains information about the touch or input from the first communication device 101, for e.g. SIP message could contain animation character: input=object A. This SIP message is transmitted via the network and is received at the second communication device 101. This information about the touch input is displayed on the second communication device 100 screen. Now the user of the first communication device 101 can speak and react accordingly, for e.g. assume that the kid's name is John, he misplaces his mother's house-keys quite often in real life. Now he has touched the house-keys on animation character displayed on the device interface. This information is seen by user of the first communication device, and he could say “John, Do not touch keys. It is bad. Yesterday you misplaced “keys” of your mother”.

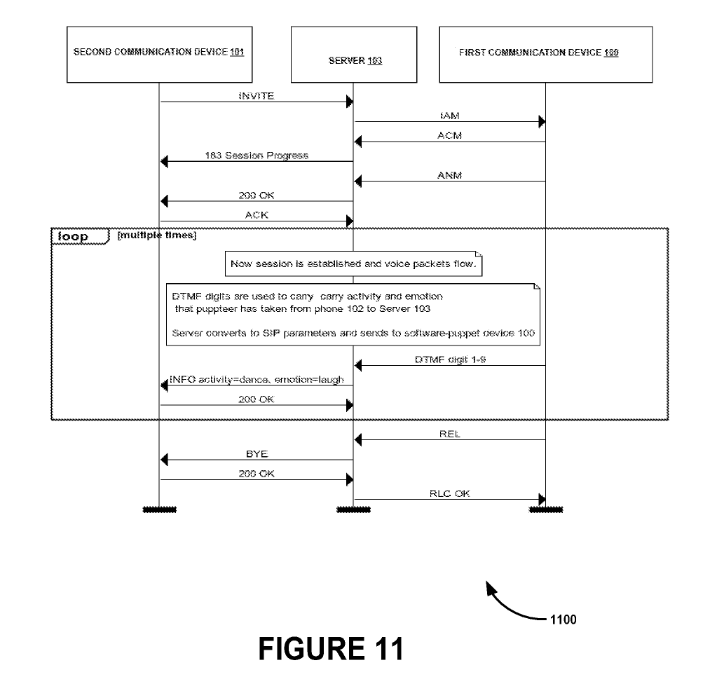

FIG. 11 is a flow diagram illustrating communication between a first communication device and a second communication device wherein the second communication device is a traditional phone, using DTMF digits, according to another embodiment herein. The first communication device 101 can connect to I E.164 equivalent of SIP-identity. In the call-flow it is assumed that the second communication device 100 initiates the call by touching the animated character or indicating his choice using keyboard or mouse. This result in generating IAM for the E.164 identity (user identity) of second communication device 101. The second communication device 101 can use dual tone multi frequency (DTMF) digits to indicate emotion and activities of the first communication device 100. These DTMF digits are received at the server 103 which translates the DTMF digit to appropriate activities and emotions and generates SIP INFO message towards the second communication device 100. A combination of two digits i.e. 0 to 99 enables first communication device 101 to control upto 100 activities, emotions of animated character which is being displayed on second communication device 100.

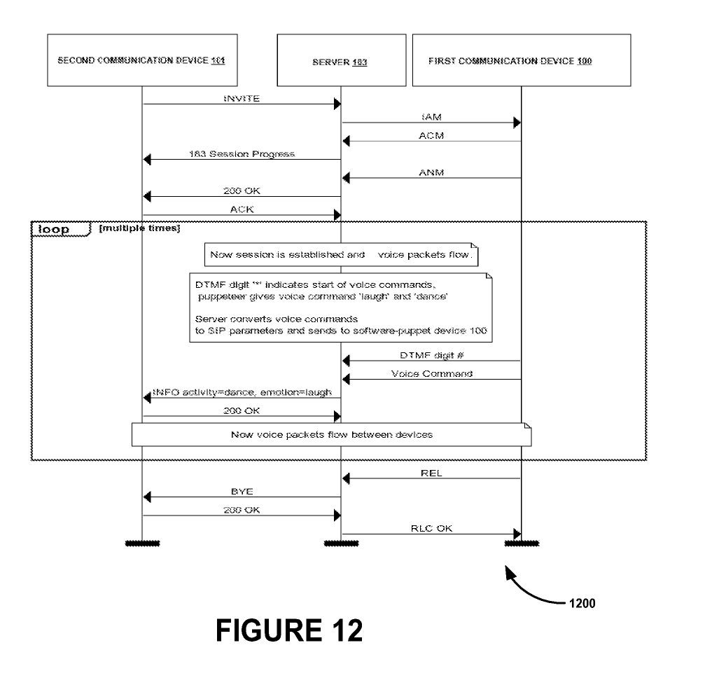

FIG. 12 is a flow diagram illustrating communication between a first communication device and second communication device, wherein the second communication device is a traditional phone, using voice commands, according to another embodiment herein. The first communication device 101 calls the E.164 equivalent of sip-identity. In the call-flow it is assumed that the kid initiates the call by touching the animated character or indicating his choice using keyboard or mouse. This results in generating IAM for the E.164 user identity of first communication device 101. Once the user of first communication device 101 answers the call is established. Now the user of first communication device 101 can use the DTMF digits ‘*’ to indicate start of the voice commands. The user of first communication device 101 can use voice-commands which are parsed by the server 103 and equivalent SIP INFO message is generated towards the device 100.

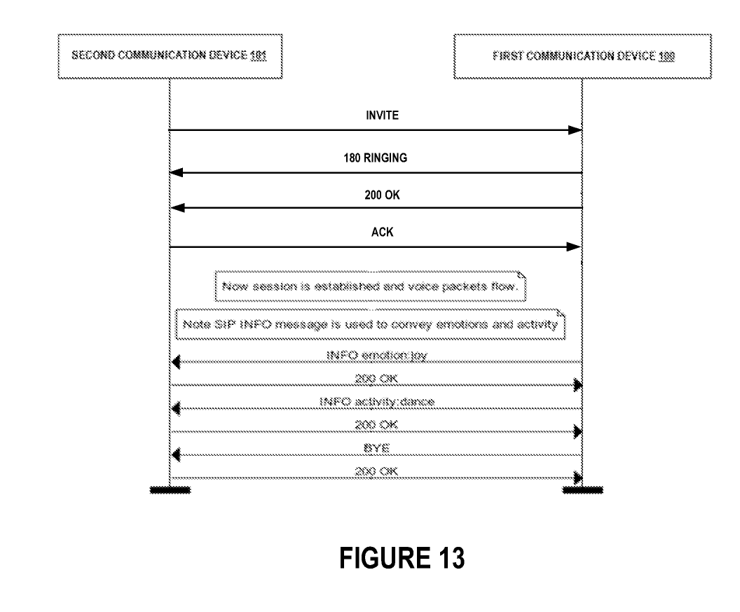

FIG. 13 is a flow diagram illustrating communication between a first communication device and second communication device when the session is established locally without transmitting via a server, according to another embodiment herein. According to one embodiment of present invention, the first communication device 101 is connected with the second communication device 100 connects locally without the server 103. The first communication device 101 and the second communication device 100 are aware of the corresponding IP address. For example, consider that the user of the first communication device 101 is a teacher and the second communication device 100 is a screen provided in a class room. The communication device of the teacher is connected with the screen provided in the class room locally, without a server 103. While presenting a lesson, story, song or any work using the animated character, there are both pre-fixed animation videos regarding the activity, animated video frames corresponding to the emotions transmitted by the teacher, lip-sync of teacher corresponding to voice signal. Some of the frames require changes in every frame based on audio coming from the first communication device 100. The animation engine herein uses a combination of two techniques; the first technique includes animation of fragments of videos and frame by frame animation. There are sequences like talking, which are being synced with real-time audio dynamically. For such sequences frame by frame animation is used.

While constructing multiple activities, emotions, expressions for fragment of videos, all fragments starts from a same frame and always end with same frame as starting frame. Typically this starting frame could show an animated character standing in an idle position. While transitioning from one fragment of video to another video it combines using same frame which brings continuity in animation, it creates an impact as if animated character is interacting with students.

Further in this embodiment, the first communication device has option to display camera feed of attached camera or network camera associated with the second communication device. The first communication device 101 also controls system aspects of the second communication device 100 such as speaker and microphone volume levels. The first communication device 101 can increase, decrease, mute or unmute speaker or microphone of the second communication device 100 by sending an additional SIP header command=<value> parameter in a SIP INFO or equivalent event message. The header command has the following values “increase_mic_volume”, “decrease_mic_volume”, “mute_mic”,unmute_mic”,“increase_speaker_volume”, “decrease_speaker_volume”, “mute_speaker”, “unmute_speaker”. “unmute_mic”,“increase_speaker_volume”,“decrease_speaker_volume”, “mute_speaker”, “unmute_speaker”. The first communication device facilitates sending of these primitives to the second communication device. Once the second communication device receives “Command” header, it extracts value of the parameter and performs appropriate function on the second communication device by using well-known methods provided by device drivers.

Although the present embodiments have been described with reference to specific example embodiments, it will be evident that various modifications and changes may be made to these embodiments without departing from the broader spirit and scope of the various embodiments. Furthermore, the various devices, modules, analyzers, generators, and the like described herein may be enabled and operated using hardware circuitry, for example, complementary metal oxide semiconductor based logic circuitry, firmware, software and/or any combination of hardware, firmware, and/or software embodied in a machine readable medium. For example, the various electrical structure and methods may be embodied using transistors, logic gates, and electrical circuits, such as application specific integrated circuit.

We claim:

1. A method of enabling communication between at least two communication devices using an animated character in real-time, the method comprising steps of:
establishing a communication session between a first communication device and a second communication device;
transmitting a voice signal and an event message from the first communication device to the second communication device;
analyzing the voice signal and an event message by a data analyzer module in the second communication device;
creating an animation sequence corresponding to the animated character based on the analysis by an animation engine;
displaying the animated character in the second communication device; and
enabling the animated character to perform a plurality of pre-defined actions on the second communication device, wherein the plurality of pre-defined actions comprises at least one of selecting an emotion or performing an activity by the animated character based on one or more control instructions from the first communication device.

2. The method of claim 1, wherein establishing a communication session comprises of:
activating a communication application pre-installed in the first communication device and the second communication; and
selecting an animated character corresponding to a pre-registered user identity.

3. The method of claim 1, wherein analyzing the voice signal comprises of:
dividing the received voice signal based on a predefined duration at a pre-defined frame rate; and
computing maximum amplitude of the voice signal for the predefined duration.

4. The method of claim 1, wherein analyzing the event message comprises of:
extracting a plurality of header attributes;
identifying one or more commands provided in a header of the event message from the extracted header attributes; and
mapping at least one of an emotion or activity based on the one or more commands in the header.

5. The method as claimed in 1 to 4, wherein creating an animation sequence comprises of:
selecting one or more image frames based on the computed amplitude of the voice signal;
selecting one or more image frames or video frames corresponding to the selected animated character;
performing a frame animation on the selected one or more image frames;
performing a video animation on the selected one or more image frames or video frames corresponding to the selected animated character based on the one or more commands in the event message; and
combining the frame animated image frames and the video animated video frames to create the animation sequence.

6. The method of claims 1 and 2, further comprising modulating the received voice signal based on the selected animated character.

7. The method of claim 1, further comprising:
checking for the reception of the event message at the second communication device; and
transferring the control of creating the animated character to a state-machine.

8. A system for enabling communication between at least two communication devices using an animated character in real-time, the system comprising:
a first communication device;
a second communication device; wherein the second communication device comprising:
an application module comprising:
a data analyzer module configured for analyzing the voice signal and an event message; and
an animation engine configured for:
creating an animation sequence corresponding to the animated character and enabling the animated character to perform a plurality of pre-defined actions on the second communication device; and
controlling the animated character based on one or more control instructions from the first communication device;
a display module configured for displaying the animated character in the second communication device.

9. The system of claim8, wherein the first communication device is configured for:
transmitting a voice signal and an event message from the first communication device to the second communication device; and
controlling the animated character based on one or more control instructions.

10. The system of claim 8, further comprising a communication server configured for storing a plurality of user identities and authenticating a communication session between a first communication device and a second communication device based on the user identities.

11. A device for enabling communication using an animated character in real-time, the device comprising of:
a communication module configured for:
establishing a communication session with another communication device; and
receiving a voice signal and an event message from another communication device;
an application module, where the application module comprises:
a data analyzer module configured for analyzing the voice signal and an event message; and
an animation engine configured for:
creating an animation sequence corresponding to the animated character based on the analysis by an animation engine; and
enabling the animated character to perform a plurality of pre-defined actions;
a user interface module for displaying the animated character.

12. The device of claim 11, further comprising a resource repository adapted for storing a plurality of pre-defined animated characters and a plurality of image frames, video frames and audio frames associated with the plurality of animated characters.

13. The device of claim 11, wherein the data analyzer module comprises:
an attribute extraction module configured for:
extracting a plurality of header attributes;
identifying one or more commands provided in a header of the event message; and
mapping at least one of an emotion or activity based on the plurality of header attributes.
a voice processing module configured for:
dividing the received voice signal based on a predefined duration at a pre-defined frame rate; and
computing maximum amplitude of the voice signal for the predefined duration.

14. The device of claimed 11, wherein the animation engine comprises:
a frame animation module configured for selecting one or more image frames based on the computed amplitude of the voice signal and performing a frame animation on the selected one or more image frames;
a video animation module configured for selecting one or more image frames or video frames corresponding to the selected animated character and performing a video animation on the selected one or more image frames or video frames corresponding to the selected animated character based on the one or more commands in the event message; and
a frame combining module configured for combining the frame animated image frames and the video animated video frames to create the animation sequence.

15. The device of claim 11, further comprising a voice modulation module configured for modulating the received voice signal based on the selected animated character.
